(19) United States
(12) Patent Application Publication
(10) Pub. No.: US 2026/0222465 A1
(43) Pub. Date: Jul. 30, 2026

(54) USER EXPERIENCE BASED RESOURCE CONFIGURATIONS

(71) Applicant: QUALCOMM Incorporated, San Diego, CA (US)

(72) Inventors: Hyun Yong LEE, San Diego, CA (US); Belal Salama Amin KORANY, San Diego, CA (US); Peerapol TINNAKORNSRISUPHAP, San Diego, CA (US); Prashanth Haridas HANDE, San Diego, CA (US); Thomas STOCKHAMMER, Bergen (DE)

(21) Appl. No.: 19/039,413

(22) Filed: Jan. 28, 2025

(51) Int. Cl. H04L 65/80

(52) U.S. Cl. CPC H04L 65/80

(57) ABSTRACT

Methods, systems, and devices for wireless communications are described. A use experience (UX) controller may receive UX information from a user equipment (UE), channel information from a network entity, or both, and may determine and transmit a resource assignment to one or more UEs based on the UX information, the channel information, or both. The UX information may indicate one or more points on the QoE-bitrate curve for uplink data, a threshold bitrate to achieve a threshold QoE value of the uplink data, one or more ranges of bitrates to achieve one or more QoE values for a quantity of frames of the uplink data, a pattern of bitrates for one or more upcoming frames of the data, or any combination thereof. The UX controller may also receive a validity duration, an accuracy, or both, of the UX information, and a threshold QoE value for application clients of the UE.

### FIELD OF TECHNOLOGY

The present disclosure relates to wireless communications, including user experience (UX) based resource configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a first indication of one or more bitrates corresponding to one or more respective quality of experience (QoE) values associated with transmission of data from the UE, receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values, and transmitting the data in accordance with the assigned bitrate, or the assigned QoE value, or both.

A UE for wireless communications is described. The UE may include one or more memories storing processor executable code, and one or more processors coupled with the one or more memories. The one or more processors may individually or collectively be operable to execute the code to cause the UE to transmit a first indication of one or more bitrates corresponding to one or more respective QoE values associated with transmission of data from the UE, receive a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values, and transmit the data in accordance with the assigned bitrate, or the assigned QoE value, or both.

Another UE for wireless communications is described. The UE may include means for transmitting a first indication of one or more bitrates corresponding to one or more respective QoE values associated with transmission of data from the UE, means for receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values, and means for transmitting the data in accordance with the assigned bitrate, or the assigned QoE value, or both.

A non-transitory computer-readable medium storing code for wireless communications is described. The code may include instructions executable by one or more processors to transmit a first indication of one or more bitrates corresponding to one or more respective QoE values associated with transmission of data from the UE, receive a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values, and transmit the data in accordance with the assigned bitrate, or the assigned QoE value, or both.

Some examples of the method, UEs, and non-transitory computer-readable medium described herein may further include operations, features, means, or instructions for transmitting, in response to a change in at least one of the data, or a channel condition of a channel associated with the UE, or a congestion metric associated with a cell that includes the UE, or a combination thereof, a third indication of one or more second bitrates corresponding to one or more respective second QoE values associated with transmission of second data from the UE.

In some examples of the method, UEs, and non-transitory computer-readable medium described herein, the one or more bitrates include a finite set of bitrates based on a quantization capability at the UE.

In some examples of the method, UEs, and non-transitory computer-readable medium described herein, the one or more bitrates include a threshold bitrate corresponding to a threshold QoE value associated with transmission of the data from the UE.

In some examples of the method, UEs, and non-transitory computer-readable medium described herein, the one or more bitrates indicate a range of possible bitrates corresponding to each of the one or more respective QoE values.

In some examples of the method, UEs, and non-transitory computer-readable medium described herein, the first indication of the one or more bitrates includes a pattern of threshold bitrates corresponding to a threshold QoE value for a set of multiple frames of the data.

Some examples of the method, UEs, and non-transitory computer-readable medium described herein may further include operations, features, means, or instructions for transmitting a third indication of a validity duration for the one or more bitrates corresponding to the one or more respective QoE values, where the validity duration includes a quantity of frames of the data, a time duration, or both.

In some examples of the method, UEs, and non-transitory computer-readable medium described herein, each bitrate of the one or more bitrates corresponds to a respective QoE value for one or more frames of the data.

Some examples of the method, UEs, and non-transitory computer-readable medium described herein may further include operations, features, means, or instructions for transmitting a third indication of an accuracy associated with the one or more bitrates of the first indication based on the one or more bitrates including one or more predicted bitrates corresponding to the one or more respective QoE values.

In some examples of the method, UEs, and non-transitory computer-readable medium described herein, transmitting the first indication of the one or more bitrates may include operations, features, means, or instructions for transmitting at least one of uplink packet metadata including the first indication, or a non-access stratum (NAS) message including the first indication, or a radio resource control (RRC) message including the first indication, or a medium access control-control element (MAC-CE) including the first indication, or an uplink control information (UCI) message including the first indication, or a combination thereof.

Some examples of the method, UEs, and non-transitory computer-readable medium described herein may further include operations, features, means, or instructions for transmitting a third indication of a threshold QoE value associated with transmission of the data from the UE, where the assigned bitrate, or the assigned QoE value, or both may be based on the third indication of the threshold QoE.

In some examples of the method, UEs, and non-transitory computer-readable medium described herein, transmitting the third indication of the threshold QoE value may include operations, features, means, or instructions for transmitting at least one of uplink packet metadata including the third indication, or a NAS message including the third indication, or an RRC message including the third indication, or a MAC-CE including the third indication, or a UCI message including the third indication, or a combination thereof.

Some examples of the method, UEs, and non-transitory computer-readable medium described herein may further include operations, features, means, or instructions for receiving a fourth indication of whether the threshold QoE value may be achievable based on current network conditions associated with a cell including the UE.

Some examples of the method, UEs, and non-transitory computer-readable medium described herein may further include operations, features, means, or instructions for receiving a third indication of one or more criteria for transmitting the first indication of the one or more bitrates, where the one or more criteria include at least one of a periodicity for transmitting the first indication, or a trigger event for transmitting the first indication, or both.

In some examples of the method, UEs, and non-transitory computer-readable medium described herein, receiving the third indication of the one or more criteria may include operations, features, means, or instructions for receiving at least one of downlink packet metadata including the third indication, or a NAS message including the third indication, or an RRC message including the third indication, or a MAC-CE including the third indication, or a UCI message including the third indication, or a combination thereof.

In some examples of the method, UEs, and non-transitory computer-readable medium described herein, receiving the second indication of the assigned bitrate, or the assigned QoE value, or both may include operations, features, means, or instructions for receiving a MAC-CE including the second indication, or a downlink control information (DCI) message including the second indication, or a combination thereof.

In some examples of the method, UEs, and non-transitory computer-readable medium described herein, the second indication of the assigned bitrate, or the assigned QoE value, or both may be received from an application server associated with the data.

Some examples of the method, UEs, and non-transitory computer-readable medium described herein may further include operations, features, means, or instructions for receiving a third indication of a percentage of uplink congestion assigned to the UE.

In some examples of the method, UEs, and non-transitory computer-readable medium described herein, the one or more bitrates indicate a frame size associated with a frame of the data, the frame size corresponding to a respective QoE value associated with transmission of the frame.

A method for wireless communications by a wireless device is described. The method may include obtaining a first indication of one or more bitrates corresponding to one or more respective QoE values associated with transmission of data from a first UE and outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

A wireless device for wireless communications is described. The wireless device may include one or more memories storing processor executable code, and one or more processors coupled with the one or more memories. The one or more processors may individually or collectively be operable to execute the code to cause the wireless device to obtain a first indication of one or more bitrates corresponding to one or more respective QoE values associated with transmission of data from a first UE and output a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

Another wireless device for wireless communications is described. The wireless device may include means for obtaining a first indication of one or more bitrates corresponding to one or more respective QoE values associated with transmission of data from a first UE and means for outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

A non-transitory computer-readable medium storing code for wireless communications is described. The code may include instructions executable by one or more processors to obtain a first indication of one or more bitrates corresponding to one or more respective QoE values associated with transmission of data from a first UE and output a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

Some examples of the method, wireless devices, and non-transitory computer-readable medium described herein may further include operations, features, means, or instructions for obtaining a third indication of channel information associated with a channel for communication with the first UE, where the assigned bitrate, or the assigned QoE value, or both may be further determined based on the third indication of the channel information.

In some examples of the method, wireless devices, and non-transitory computer-readable medium described herein, the first indication of the one or more bitrates corresponding to the one or more respective QoE values may be obtained from at least a network entity, or an application server associated with the data, or both.

Some examples of the method, wireless devices, and non-transitory computer-readable medium described herein may further include operations, features, means, or instructions for receiving a set of multiple third indications of threshold QoE values associated with transmission of data from a set of multiple UEs including the first UE, where the assigned bitrate, or the assigned QoE value, or both may be based on the set of multiple third indications and determining the assigned bitrate, or the assigned QoE value, or both based on available wireless communication resources and the set of multiple third indications of the threshold QoE values.

Some examples of the method, wireless devices, and non-transitory computer-readable medium described herein may further include operations, features, means, or instructions for determining the assigned bitrate, or the assigned QoE value, or both based on a minimum QoE value associated with any UE of a set of multiple UEs including the second UE.

In some examples of the method, wireless devices, and non-transitory computer-readable medium described herein, the wireless device includes at least a separate entity from a network entity that may be a recipient of the data from the first UE, a logical entity of the network entity, or both.

In some examples of the method, wireless devices, and non-transitory computer-readable medium described herein, the second indication of the assigned bitrate, or the assigned QoE value, or both may be outputted to an application server associated with the data.

In some examples of the method, wireless devices, and non-transitory computer-readable medium described herein, the second indication of the assigned bitrate, or the assigned QoE value, or both may be outputted in response to the assigned bitrate, or the assigned QoE, or both being different than a previously assigned bitrate, or a previously assigned QoE value, or both.

In some examples of the method, wireless devices, and non-transitory computer-readable medium described herein, the second UE includes the first UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user experience (UX) based resource configurations in accordance with one or more aspects of the present disclosure.

FIG. 2 shows an example of a wireless communications system that supports UX based resource configurations in accordance with one or more aspects of the present disclosure.

FIG. 3 shows an example of a quality of experience (QoE)-bitrate indication diagram that supports UX based resource configurations in accordance with one or more aspects of the present disclosure.

FIG. 4 shows an example of a process flow that supports UX based resource configurations in accordance with one or more aspects of the present disclosure.

FIGS. 5 and 6 show block diagrams of devices that support UX based resource configurations in accordance with one or more aspects of the present disclosure.

FIG. 7 shows a block diagram of a communications manager that supports UX based resource configurations in accordance with one or more aspects of the present disclosure.

FIG. 8 shows a diagram of a system including a device that supports UX based resource configurations in accordance with one or more aspects of the present disclosure.

FIGS. 9 and 10 show block diagrams of devices that support UX based resource configurations in accordance with one or more aspects of the present disclosure.

FIG. 11 shows a block diagram of a communications manager that supports UX based resource configurations in accordance with one or more aspects of the present disclosure.

FIG. 12 shows a diagram of a system including a network entity that supports UX based resource configurations in accordance with one or more aspects of the present disclosure.

FIGS. 13 and 14 show flowcharts illustrating methods that support UX based resource configurations in accordance with one or more aspects of the present disclosure.

### DETAILED DESCRIPTION

In some wireless communications systems, a user equipment (UE) may transmit data (e.g., uplink data) that is encoded according to a bitrate, where higher bitrates may correspond to improved quality of experience (QoE) values at the UE or for the user of the UE. For example, a higher bitrate may provide for increased frame sizes of video data, decreased latency at the UE and for a user of the UE, or both. A QoE-bitrate curve may be a graphical representation of a relationship between bitrate and QoE values for a set of data. In some cases, increasing the bitrate for encoding the data may provide diminishing increases to QoE values. Additionally, different data (e.g., different scenes or frames) may be associated with different QoE-bitrate curves, such that complex data (e.g., complex frames, frames with a large frame size) may utilize a higher bitrate than simple data (e.g., simple frames, frames with a small frame size) to achieve a same QoE value. A wireless communications system may provide a finite amount of bitrate (e.g., finite resources for wireless communication resource) for multiple UEs to utilize for transmitting data. Additionally, UEs with a higher channel quality (e.g., less noise) may use a higher bitrate than UEs with lower channel quality. However, in some cases, the UEs with the higher channel quality may use a higher bitrate to transmit relatively simple data while the UEs with lower channel quality may be left with a lower bitrate to transmit relatively more complex data, which may only incrementally increase the QoE value for the simple data while majorly decreasing the QoE value of the more complex data (e.g., based on respective QoE-bitrate curves of the simple and complex data). In some cases, techniques to improve bitrate and QoE allocation in a wireless communications system may improve QoE values for complex data with relatively minor tradeoffs for simple data.

According to techniques described herein, one or more UEs may transmit user experience (UX) information to a UX controller, where the UX controller may determine and transmit a resource assignment (e.g., UX feedback, an assigned bitrate, assigned QoE, or both) to one or more UEs based on the UX information. The UX controller may also receive channel information from a network entity, and the resource assignment may also be determined based on the channel information. In some cases, the UX information from the UE may be an indication of one or more bitrates that correspond to one or more QoE values associated with transmission of data from the UE (e.g., information associated with the QoE-bitrate curve of the data). For example, the UX information may indicate one or more points on the QoE-bitrate curve for the data, a threshold (e.g., minimum) bitrate to achieve a threshold QoE value of the data, one or more ranges of bitrates to achieve one or more QoE values for a quantity of frames of the data, a pattern of bitrates for one or more upcoming frames of the data, or any combination thereof. In some cases, the UE may transmit (e.g., as part of the UX information or separately) a validity duration for the UX information, an accuracy of the UX information, or any combination thereof. In some cases, one or more application clients of the UE may provide the UX information to other components or systems of the UE. Additionally, each application client may transmit, to the UX controller (e.g., via the UE) an indication of a threshold QoE value associated with the application client, and the resource assignment may also be based on the threshold QoE values. In some cases, the UX controller may be a network entity, a logical entity (e.g., a distributed unit) within a network entity associated with the UE, or an entity separate from the network entity. Based on implementing the techniques described herein, an average or minimum QoE value for multiple UEs in a wireless communications system may be increased based on intelligent redistribution of bitrate or QoE determined by the UX controller according to the UX information from the multiple UEs and the channel information from the network entities.

Aspects of the disclosure are initially described in the context of wireless communications systems. Aspects of the disclosure are also described with respect to QoE-bitrate indication diagrams and process flows. Aspects of the disclosure are further illustrated by and described with reference to apparatus diagrams, system diagrams, and flowcharts that relate to UX based resource configurations.

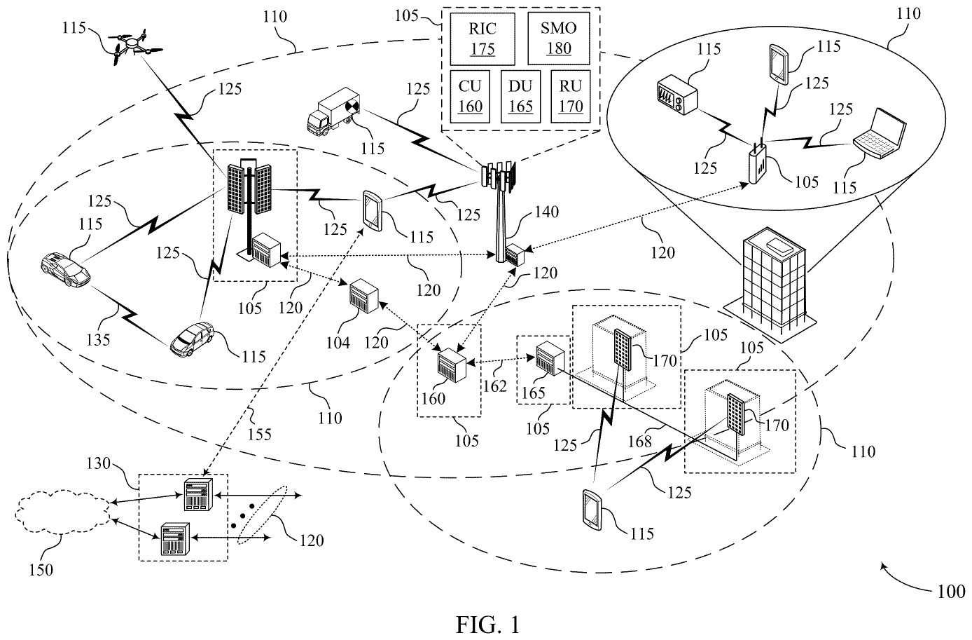

FIG. 1 shows an example of a wireless communications system 100 that supports UX based resource configurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165 (e.g., an evolved DU (eDU)), a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support UX based resource configurations as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In cases, a UE 115 may transmit data that is encoded according to a bitrate, where higher bitrates may correspond to improved QoE values at the UE 115 or for the user of the UE 115. For example, a higher bitrate may provide for increased frame sizes of video data, decreased latency at the UE 115 and for a user of the UE 115, or both. In some cases, increasing the bitrate for encoding the data may provide diminishing increases to QoE values. Additionally, complex data may utilize a higher bitrate than simple data to achieve a same QoE value. In some cases, the wireless communications system 100 may provide a finite amount of bitrate (e.g., finite resources for wireless communication resource) for multiple UEs 115 to utilize for transmitting data. Additionally, UEs 115 with a higher channel quality may use a higher bitrate than UEs 115 with lower channel quality. However, in some cases, the UEs 115 with the higher channel quality may use the higher bitrate to transmit relatively simple data while the UEs 115 with lower channel quality may be left with a lower bitrate to transmit relatively more complex data, which may only incrementally increase the QoE value for the simple data while majorly decreasing the QoE value of the more complex data. In some cases, techniques to improve bitrate and QoE allocation in a wireless communications system may improve QoE values for complex data with relatively minor tradeoffs for simple data.

According to techniques described herein, one or more UEs 115 may transmit UX information to a UX controller of the wireless communications system 100, where the UX controller may determine and transmit a resource assignment (e.g., UX feedback, an assigned bitrate, assigned QoE, or both) to one or more UEs 115 based on the UX information. The UX controller may also receive channel information from a network entity, and the resource assignment may also be determined based on the channel information. In some cases, the UX information from the UEs 115 may be an indication of one or more bitrates that correspond to one or more QoE values associated with transmission of data from the UE. For example, the UX information may indicate one or more points on a QoE-bitrate curve for the data, a threshold (e.g., minimum) bitrate to achieve a threshold QoE value of the data, one or more ranges of bitrates to achieve one or more QoE values for a quantity of frames of the data, a pattern of bitrates for one or more upcoming frames of the data, or any combination thereof. In some cases, each UE 115 may transmit (e.g., as part of the UX information or separately) a validity duration for the UX information, an accuracy of the UX information, or any combination thereof. In some cases, an application client associated with a UE 115 may generate and transmit the UX information. Additionally, or alternatively, the application clients may indicate one or more threshold QoE values associated with each of the one or more application clients for use at the UE 115, the UX controller, or both. In some cases, the UX controller may be a network entity 105, a logical entity (e.g., a DU) within a network entity 105, or a separate entity from the network entity 105. Based on implementing the techniques described herein, an average or minimum QoE value for multiple UEs 115 in a wireless communications system may be increased based on intelligent redistribution of bitrate or QoE determined by the UX controller according to the UX information from the multiple UEs 115 and the channel information from the network entities 105.

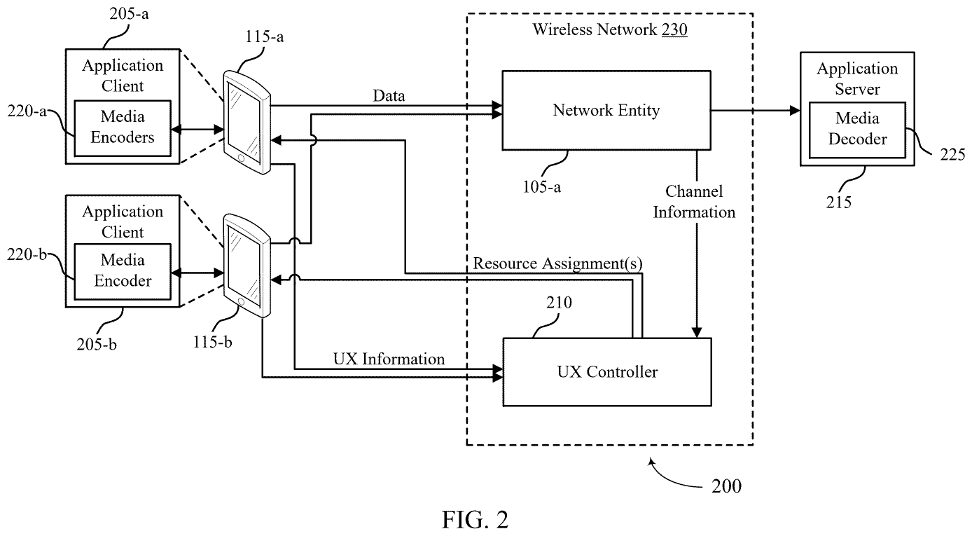

FIG. 2 shows an example of a wireless communications system 200 that supports UX based resource configurations in accordance with one or more aspects of the present disclosure. In some cases, aspects of the wireless communications system 200 may implement or be implemented by aspects of FIG. 1. For example, the wireless communications system 200 may include UEs 115 (e.g., a UE 115-a, a UE 115-b) a network entity 105-a, and a UX controller 210, which may be examples of the UEs 115, the network entities 105, and the UX controller described with respect to FIG. 1. Additionally, the wireless communications system 200 may include one or more application clients 205 (e.g., an application client 205-a, an application client 205-b, application clients within the UEs 115) and an application server 215. In some aspects, the UX controller 210 may determine and transmit a resource assignment to one or more of the UEs 115 based on UX information, channel information, or both, received from the UEs 115 (e.g., from the application clients 205) and the network entity 105-a, respectively.

Wireless communications systems may implement varying techniques to provide high QoE or quality of service (QoS) to UEs 115. For example, some wireless communications systems (e.g., 4G and 5G system) may provide a guaranteed bitrate for low latency applications. However, such techniques may not allow for scaling to large quantities of UEs 115, may lead to poor utilization of resources (e.g., due to cell edge users), and may increase costs for operators of network entities 105. Additionally, or alternatively, some wireless communications systems (e.g., 5G systems) may utilize an adaptive rate allocation technique. For example, such an adaptive rate allocation technique may allow for fluctuating bitrates and QoE/QoS at UEs 115, but may not provide a guaranteed bitrate, may not account for UX (e.g., such as QoE or QoS, referred to herein as QoE), and may lead to a reduced quantity of UEs 115 able to simultaneous meet a threshold QoE value (e.g., compared to techniques described herein).

Some wireless communications systems may implement the adaptive rate techniques for multimedia applications (e.g., such as for extended reality (XR) or virtual reality (VR) applications). In some cases, adaptive rate control mechanisms may depend on end-to-end feedback between UEs 115 and network entities 105, which may be relatively slow and may not account for QoE values for the UEs 115. For example, such mechanisms may result in asymmetry in QoE values among multiple UEs 115. In one example, if a first UE 115 uses a same bitrate to transmit relatively simple data (e.g., simple scene content, data with a relatively small frame rate or frame size) as a second UE 115 uses to transmit relatively complex data, the same bitrate may provide more than enough resource for transmitting the simple data with a high QoE value, while the bitrate may not provide sufficient resource for transmitting the complex data with a high QoE value. That is, the simple data may overtake the radio resources without large or noticeable improvement of UX.

In another example, each UE 115 may be unaware of link conditions or load conditions at each other UE 115, and a network entity 105 may be unaware of threshold QoE values or QoE-bitrate curves for data sent from each UE 115. This may result in gaps in bitrates assigned to UEs with asymmetric channel conditions. For example, UEs 115 with good channel conditions (e.g., low noise levels) may select high bitrates to encode data (e.g., resulting in an unnecessarily high QoE for simple data), while UEs 115 with worse channel conditions may receive relatively low bitrates (e.g., resulting in a low QoE for complex data). However, a QoE value at the UE 115 (e.g., or a UX of a user of the UE 115) may flatten or saturate as the bitrate increases, which may result in some UEs 115 (e.g., those with relatively good channel conditions) utilizing more resources with little QoE gain while other users (e.g., with relatively bad channel conditions) may be incapable of receiving sufficient resources to maintain a high QoE value.

In downlink communication (e.g., from the network entity 105 to the UEs 115), some UX or QoE aware techniques may address some uneven bitrate allocation issues. For example, a RAN may receive information and provide a bitrate to the network entities 105 or application servers 215 to provide more symmetry in a QoE value for different UEs 115. However, such techniques may not be applicable to uplink traffic (e.g., data being transmitted from UEs 115 to network entities 105). Some examples of uplink traffic may include performing local device rendering (e.g., in a conversational video call, in an avatar call, for a hologram, for device to device (D2D) signaling), perception offloading (e.g., adjusting and uploading camera frames, XR or VR), or other operations that may involve varying complexity of data and are affected by assigned bitrates at the UEs 115.

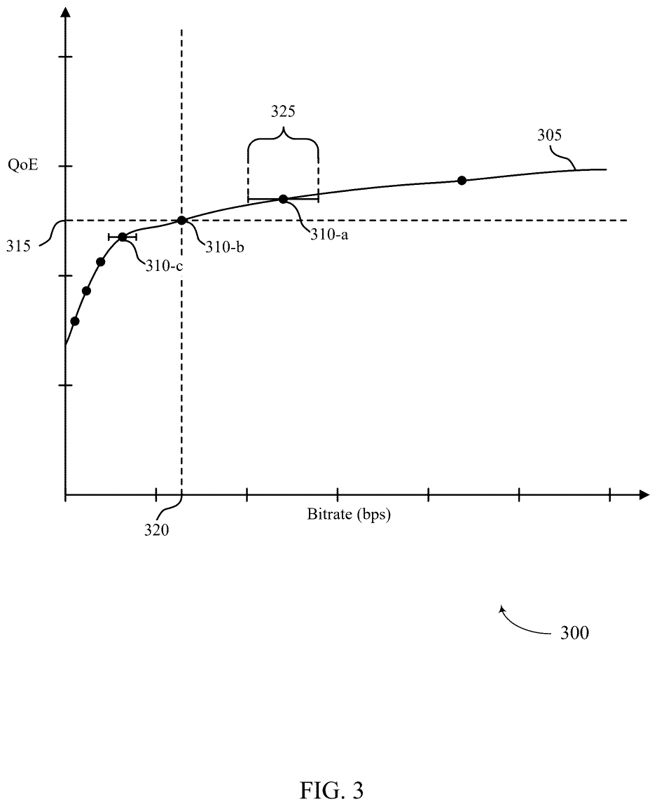

In uplink scenarios, a QoE-bitrate curve (e.g., such as a QoE-bitrate curve 305 illustrated in FIG. 3) may be a graphical representation of a relationship between a prospective bitrate for a set of data (e.g., one or more frames) and a QoE (e.g., a peak signal-to-noise ratio (PSNR), a latency measurement, one or more other QoE-related measurements) for transmitting the data from a UE 115. In some cases, QoE-bitrate curves may be different for different UEs 115, different data (e.g., different scene content and different codec algorithms), and different link or channel conditions. Additionally, increases in bitrate along a QoE-bitrate curve may lead to diminishing increases in QoE (e.g., a slope of the QoE-bitrate curve may decrease as bitrate increases), such that the QoE may flatten or saturate as bitrate increases. Additionally, data (e.g., scene content in video data) may vary over time, and thus the QoE-bitrate curve may vary over time.

In uplink scenarios, intelligent resource allocation (e.g., based on QoE information and channel conditions) may increase QoE values for UEs 115 with poor channel conditions while effectively maintaining the QoE values for UEs 115 with good channel conditions. For example, a wireless communications system that is aware of the impact of resource allocation to UX (e.g., QoE) for users may allow relatively complex data to use more resources (e.g., bitrate) to satisfy threshold QoE values, which may lead to more efficient use of resource, improved UX, and higher QoE capacity with fixed resource.

The UX controller 210 may be part of a wireless network 230 (e.g., a RAN, the network entity 105-a, a logical entity integrated in the wireless network 230 such as a DU, a separate entity from the network entity 105-a) and may be responsible for determining resource assignment for UEs 115 in the wireless communications system 200 based on UX information from the UEs 115 (e.g., from application clients 205) and channel information from the network entity 105-a. For example, the UX controller 210 may receive real-time UX information (e.g., a QoE-bitrate curve, a threshold QoE value) from media encoders 220 (e.g., a media encoder 220-a, a media encoder 220-b) associated with the UEs 115 (e.g., media encoders 220 in user devices including the UEs 115 and associated with application clients associated with the UEs 115) or media decoders 225 in application servers 215, channel information from network entities 105, or both. The UX controller 210 may determine and transmit resource assignments (e.g., assigned bitrates, assigned QoE values) back to the UEs 115 and application clients 205 based on the received information. In some cases, UX information from each UE 115 in the wireless communications system 200 may affect a resource assignment for each or every UE 115 in the wireless communications system 200. The UX controller 210 may receive the UX information and channel information, determine the resource assignments, and output the resource assignments periodically or based on changes in data, channel conditions, or wireless communications system load.

In some cases, the application clients 205 may be data services that are responsible for media encoding and other computing operations for a UE 115. For example, different applications (e.g., video streaming applications, media uploading applications such as XR or VR, social media) may be associated with application clients 205 for a UE 115. In some cases, an application client 205 may estimate the UX information (e.g., a QoE-bitrate curve) for a set of data (e.g., for one or more frames or segments of data), and may deliver the UX information to the UE 115 to be transmitted to the UX controller 210. Thus, as used herein, a UE 115 generating or transmitting UX information to the UX controller 210 may include the application clients 205 generating and communicating the UX information to the UEs 115 or directly to the UX controller 210.

In some cases, the UX controller 210 may run optimization algorithms to determine the resource assignments in order to improve UX and network uplink utility in the wireless communications system 200. The optimization algorithms may attempt to optimize various parameters. In some cases, the UX controller 210 may attempt to increase (e.g., maximize) a quantity of UEs 115 in the wireless communications system that satisfy a related threshold QoE value. That is, the UX controller 210 may attempt to increase (e.g., maximize) a QoE capacity of the wireless communications system 200, where a QoE capacity for a wireless communications system may be a quantity of UEs 115 that the wireless communications system 200 can support while a threshold percentage (e.g., 90%) of the quantity of UEs 115 experience a QoE value that satisfies a threshold QoE value. Additionally, or alternatively, the UX controller 210 may attempt to increase (e.g., maximize) a lowest QoE value experienced by any UE 115 in the wireless communications system 200. For example, even if multiple UEs 115 are not satisfying a threshold QoE value, the UX controller 210 may attempt to increase (e.g., maximize) the lowest QoE value experienced in the wireless communications system 200. Additionally, or alternatively, the UX controller may determine the resource assignment to increase (e.g., maximize) an average QoE value experienced by the multiple UEs 115 while maintaining each threshold QoE value (e.g., or as many threshold QoE values as possible).

Accordingly, the UEs 115 of wireless communications system 200 may experience increased UX (e.g., increased QoE or QoS values) based on the resource assignments determined by the UX controller 210. In some aspects, FIG. 3 may describe the UX information transmitted to the UX controller 210.

FIG. 3 shows an example of a QoE-bitrate indication diagram 300 that supports UX based resource configurations in accordance with one or more aspects of the present disclosure. In some cases, aspects of the QoE-bitrate indication diagram 300 may implement or be implemented by aspects of FIGS. 1 and 2. In some cases, the vertical axis of the QoE-bitrate indication diagram 300 may be any QoE metric (e.g., PSNR, video multi-method assessment fusion (VMAF), latency measurements, etc.), and the horizontal axis may be a possible bitrate for encoding and sending a set of data (e.g., which may be interpretated as a frame size for a frame of the data). A QoE-bitrate curve 305 may indicate a relationship between the bitrate used to encode and transmit the data and a resultant QoE value associated with transmitting the data. In some aspects, the QoE-bitrate indication diagram 300 may illustrate information indicated in the UX information that is transmitted from the UEs 115 to the UX controller 210 (e.g., as described in FIG. 2).

The UX information may include various descriptions of the QoE-bitrate curve 305. For example, the UX information may indicate one or more points 310 (e.g., a point 310-a, a point 310-b, a point 310-c) on the QoE-bitrate curve. For example, the UX information may indicate N points 310 on the QoE-bitrate curve 305, where N may be greater than or equal to one, and each point 310 may be indicated by 2 corresponding values (e.g., a bitrate and a corresponding QoE value). In some cases, a media encoder associated with the UEs 115 (e.g., such as the media encoders 220 of FIG. 2) may not be capable of implementing every bitrate on the QoE-bitrate curve 305 (e.g., based on N-bit quantization), and thus the one or more points 310 may include a set or subset of implementable bitrates at the media encoder.

Additionally, or alternatively, the UX information may include a threshold bitrate 320 (e.g., a minimum bitrate) to maintain a threshold QoE value 315. For example, the UX information may indicate a single point (e.g., such as point 310-b) on the QoE-bitrate curve 305 that indicates the threshold bitrate 320 and the threshold QoE value 315. Alternatively, the UX information may indicate the threshold bitrate 320 (e.g., without indicating the threshold QoE value 315). In some cases, the threshold bitrate 320 may change dynamically over time with different data (e.g., based on complexity of video content, for example), and thus the threshold bitrate 320 may be updated regularly at the UX controller (e.g., more often than other UX information).

Additionally, or alternatively, the UX information may indicate a range 325 of bitrates associated with one or more QoE values on the QoE-bitrate curve 305. For example, to indicate a range 325, the UX information may indicate one or more of a minimum bitrate, a maximum bitrate, an average (e.g., center, middle) bitrate, a variance (e.g., distance from the average bitrate to one or more of the maximum and the minimum bitrate), a size of the range 325, or any combination thereof, of the range 325. In some cases, the maximum bitrate of a range 325 (e.g., whether explicitly or implicitly indicated) may form a threshold bitrate that the UX controller may respect (e.g., even if available bitrate allows for more). In some cases, each range 325 of bitrates for each QoE value may be the same or differently sized. For example, a range 325 for a point 310-c that is associated with more change in QoE per change in bitrate (e.g., a large slope or derivative) may be associated with a smaller size, and a point 310-a associated with less change in QoE per change in bitrate may be associate with a larger range 325. In some cases, the QoE-bitrate curve 305 may be a predicted QoE-bitrate curve for a future transmission, and thus the range 325 of bitrates may indicate a predicted range of bitrates to account for inaccuracies in estimating the QoE-bitrate curve 305. Additionally, the QoE-bitrate curve 305 may vary over a quantity of future frames of data, and thus the ranges 325 may be a predictive range of bitrates to maintain a corresponding QoE over the quantity of future frames.

In some cases, the UX information may indicate a pattern of bitrates to maintain respective threshold QoE values 315 for one or more future frames. For example, the UX information may indicate M bitrates, where a first bitrate of the M bitrates may correspond to a first set of one or more frames, a second bitrate of the M bitrates may correspond to a subsequent set of one or more frames, and so on through each of the M bitrates. Additionally, or alternatively, a set of values (e.g., two values, “0” and “1”) may correspond to a set of respective bitrates (e.g., two bitrates, a high bitrate and a low bitrate), and the UX information may indicate a pattern of the values from the set of values. Each value in the pattern may indicate a requested bitrate to achieve the threshold QoE value for a corresponding future set of one or more frames of the data.

In some cases, a UE 115 may provide other information with the UX information (e.g., within the UX information or separately from the UX information). For example, the other information may indicate a validity duration for the UX information. For example, the validity duration may be a duration for which the UX information may be above a threshold of accuracy. In some cases, the validity duration may indicate a quantity of N next frames of data for which the UX information may be valid, a quantity of time (e.g., milliseconds (ms)) for which the UX information is valid, or both. In some cases, the validity duration may be based on an expected consistency of the QoE-bitrate curve 305 (e.g., expected scene change, user header motion).

Additionally, or alternatively, the other information may include an accuracy of the UX information. For example, if the UX information includes predicted UX information (e.g., such as for future frames), the UE 115 may transmit a predicted accuracy (e.g., based on previous performance, based on data from an application client) of the UX information to the UX controller. In some cases, the UE 115 may include the indication of the accuracy in the UX information (e.g., in a same transmission) or in a separate transmission. In some cases, the other information (e.g., including the validity duration, the accuracy, or both) may be statically configured for all UX information, semi-statically configured for UX information, or dynamically indicated for each UX information.

In some cases, the UE 115 may indicate UX information (e.g., according to any example described herein) to the UX controller for one or more groups of future frames of the data. For example, the data may include a plurality of frames that may be split into a plurality of groups, where each group may include some quantity of consecutive frames of the data. The UE 115 may transmit separate UX information for each group of frames (e.g., one transmission with UX information for each group of frames). For example, the data may include ten frames, where a first group of frames may include the first three frames, a second group of frames may include the next one frame, and a third group of frames may include a final six frames of the ten frames. The UE 115 may transmit three UX informations (e.g., in one transmission or multiple), including a first UX information for the first group, a second UX information for the second group, and a third UX information for the third group.

The UE 115 may transmit any combination of the described UX information and other information to the UX controller. For example, the UX information may include multiple points 310 and a range 325 associated with each point 310. Additionally, or alternatively, the UX information may indicate a pattern of ranges 325 of bitrates for one or more groups of future frames of the data, and an accuracy associated with each range 325 of the pattern. These are merely examples and are in no way limiting to the combinations of the techniques described herein.

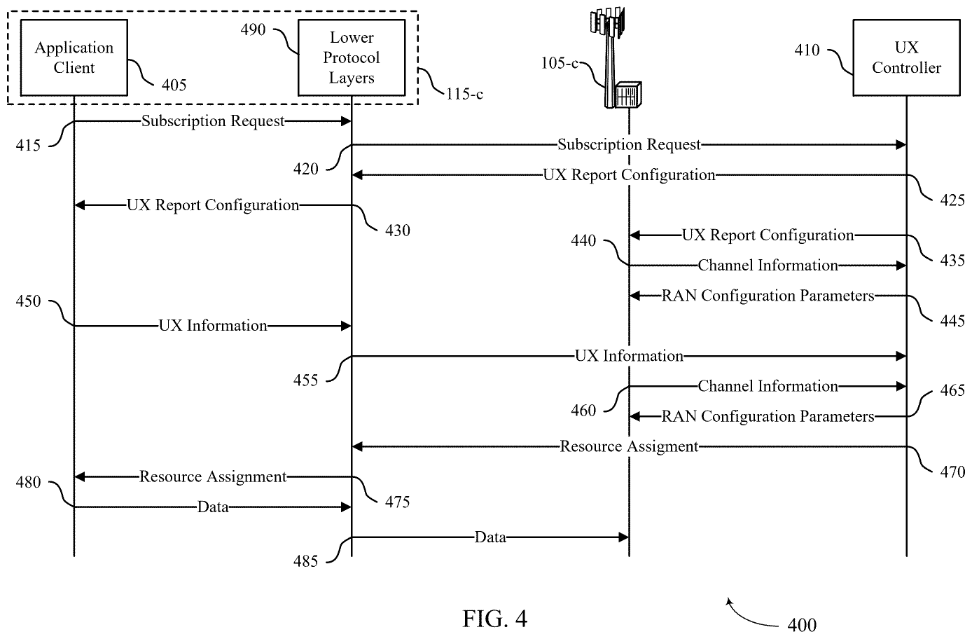

FIG. 4 shows an example of a process flow 400 that supports UX based resource configurations in accordance with one or more aspects of the present disclosure. In some cases, aspects of the process flow 400 may implement or be implemented by aspects of FIGS. 1-3. For example, the process flow 400 may include a UE 115-c, a network entity 105-c, an application client 405 within the UE 115-c, and a UX controller 410, which may be examples of UEs 115, network entities 105, the application clients 205, and the UX controller 210, as described herein with respect to FIGS. 1 and 2. The UE 115-c may also include lower protocol layers 490, which may be further described herein with respect to FIG. 1 (e.g., functionality of the UE 115-c that hosts the lower protocol layers, such as L1 (e.g., PHY layer) or L2 (e.g., RLC layer, MAC layer). In some aspects, the UX controller 410 may intelligently assign (e.g., distribute) communication resources (e.g., bitrate) to UEs 115 (e.g., including the UE 115-c, to application clients 405 associated with the UEs 115) based on UX information from the application client 405 (e.g., from the UE 115-c) and channel information from the network entity 105-c.

In the following description of process flow 400, the operations may be performed in a different order than the order shown, or other operations may be added or removed from the process flow 400. For example, some operations may be left out of process flow 400, may be performed in different orders or at different times, or other operations may be added to process flow 400. Although the UE 115-c, the network entity 105-c, the application client 405, lower protocol layers 490 of the UE 115-c, and the UX controller 410 are shown performing the operations of process flow 400, some aspects of some operations may also be performed by one or more other wireless devices, network devices, or protocol layers. For example, information received at or outputted from the UX controller 410 (e.g., such as the UX information, the UX report configuration, or the resource assignment) may be received or outputted from or to one or more other devices than are shown in the process flow 400, as described herein. Additionally, or alternatively, the UE 115-c may transmit or receive signaling from or to the lower protocol layers 490, and thus transmitting signaling from the UE 115-c or receiving signaling at the UE 115-c may be synonymous with transmitting signaling from the lower protocol layers 490 of the UE 115-c or receiving signaling at the lower protocol layers 490 of the UE 115-c.

At 415, the application client 405 may transmit a subscription request to the lower protocol layers 490. For example, the subscription request may request subscription of the application client 405 with the UX controller 410. In some cases, the application client 405 may transmit the subscription request to the lower protocol layers 490 so that the UE 115-c may forward the subscription request to the UX controller 410.

At 420, the UE 115-c (e.g., the lower protocol layers 490) may transmit the subscription request to the UX controller 410. In some cases, the subscription request may also include a subscription request for the UE 115-c to subscribe with the UX controller 410. In some cases, the UX controller 410 (e.g., a wireless device) may be an entity separate from the network entity 105-c (e.g., a network entity 105 that is a recipient of uplink data from the UE 115-c), a logical entity of the network entity 105-c (e.g., an eDU, a DU), or both.

At 425, the UE 115-c (e.g., the lower protocol layers 490) may receive a UX report configuration, which may be an indication of one or more criteria for transmitting UX information from the UE 115-c to the UX controller 410 (e.g., including communicating the UX information from the application client 405 to the lower protocol layers 490). In some cases, the one or more criteria may include at least one of a periodicity for updating the UX information, or one or more trigger events for updating the UX information, or both. For example, the periodicity may be indicated as a quantity of frames, a time duration (e.g., in ms), or both. In some cases, the periodicity may be at least once per frame of a set of data (e.g., the period may be the inverse of a frame rate, such as 1/frames-per-second (fps)). In some cases, the one or more trigger events may include a change in at least one of the set of data, or a channel condition of a channel associated with the UE 115-c, or a congestion metric associated with a cell that includes the UE 115-c, or a combination thereof.

In some cases, the UX controller 410 may communicate the UX report configuration to the UE 115-c in various manners. In one example, the UX controller 410 may transmit the UX report configuration to the lower protocol layers 490 via NAS signaling, RRC signaling, or a MAC-control element (CE). For example, the UX controller 410 may communicate the UX report configuration to the lower protocol layers 490 during a PDU session establishment procedure. Additionally, or alternatively, the UX controller 410 may transmit the UX report configuration in metadata of a protocol data unit (PDU) set (e.g., such as a real-time transport protocol (RTP)-header extension (HE), further described herein at 455), or in any control signaling packet over a user plane associated with the UE 115-c. In another example, the UX controller 410 may communicate the UX report configuration to an application server associated with the application client 405, and the application server may transmit the UX report configuration to the application client 405.

At 430, the lower protocol layers 490 may forward the UX report configuration to the application client 405. For example, the lower protocol layers 490 may send the UX report configuration (e.g., including the one or more criteria) to the application client via a cross-layer application programming interface (API).

At 435, the UX controller 410 may transmit a UX report configuration to the network entity 105-c, where the UX report configuration may indicate one or more criteria for the network entity 105-c to transmit (e.g., output, indicate) channel information to the UX controller 410. For example, the one or more criteria may include a periodicity, a trigger event, or both, for transmitting the channel information to the UX controller 410. In some cases, the one or more trigger events may include the UX controller 410 receiving UX information from the UE 115-c, a change in the channel information (e.g., a decrease or increase in channel condition), or other trigger events. In some cases, the periodicity for the network entity 105-c to report channel information to the UX controller 410 may be higher (e.g., more frequent) or lower (e.g., less frequent) than the periodicity for the UE 115-c to update UX information at the UX controller 410.

At 440, the network entity 105-c may output (e.g., and the UX controller 410 may obtain) an indication of channel information associated with a channel for communication between the network entity 105-c and the UE 115-c. In some cases, the channel information may include uplink-related information, which may include an available bitrate for one or more (e.g., each) UEs 115 in a wireless communications system including the UE 115-c, a network congestion level, a rank or modulation and coding scheme (MCS) for one or more (e.g., each) UEs 115 in the wireless communications system (e.g., including the UE 115-c), a block error rate (BLER), or a combination thereof.

At 445, the UX controller 410 may output, to the network entity 105-c, one or more RAN configuration parameters. For example, the one or more RAN configuration parameters may include parameters for adapting functions at the network entity 105-c to improve one or more QoE levels for UEs 115 in the wireless communications system. In some cases, the RAN configuration parameters may be based on UX information from the UE 115-c (e.g., and one or more other UEs 115 in the wireless communications system), and may include an indication of one or more assigned resources (e.g., assigned bitrates, assigned QoE levels, both) for each UE 115 (e.g., each application client 405) in the wireless communications system.

At 450, the application client 405 may transmit, to the lower protocol layers 490, an indication of UX information for a set of data. The UX information may be further described at 455 and with respect to FIG. 3.

Additionally, or alternatively, the application client 405 may transmit (e.g., in the UX information or separately) an indication of a threshold QoE associated with the application client 405 (e.g., to the UX controller 410 directly, or to the lower protocol layers 490). For example, each application client 405 associated with the UE 115-c may be associated with a respective (e.g., different) threshold QoE value for performing operations associated with the application. Various manners of communicating the threshold QoE value from the application client 405 to the UX controller 410 may be described at 455.

At 455, the UE 115-c (e.g., the lower protocol layers 490) may transmit the UX information (e.g., received from the application client), which may be an indication of one or more bitrates corresponding to one or more respective QoE values associated with transmission of data from the UE 115-c. The UX information may be intended for the UX controller 410, but may be transmitted from the UE 115-c to one or more entities and forwarded from the one or more entities to the UX controller. In one example, the UE 115-c may transmit the UX information directly to the UX controller 410. In some other examples, the UE 115-c may transmit the UX information to an application server associated with the data, to the network entity 105-c, or both, and the UX controller 410 may obtain the UX information from the network entity 105-c, or the application server associated with the data, or both.

In some cases, the UX information from the UE 115-c (e.g., the one or more bitrates corresponding to one or more respective QoE values associated with transmission of data from the UE 115-c) may include various indications (e.g., as described with respect to FIG. 3). For example, UX information (e.g., the one or more bitrates) may include a finite set of bitrates (e.g., not an expression of a function, tabulated or discrete values) based on a quantization capability at the UE 115-c (e.g., of a media encoder of the application client 405, such as the media encoders 220 of FIG. 2). Additionally, or alternatively, the UX information may include a threshold bitrate corresponding to a threshold QoE value associated with transmission of the data from the UE (e.g., a threshold QoE value of the application client 405 associated with the data, a threshold QoE value determined by the UE 115-c). Additionally, or alternatively, the UX information may indicate a range of possible bitrates corresponding to each of the one or more respective QoE values. Additionally, or alternatively, the UX information may indicate a pattern of threshold bitrates corresponding to a threshold QoE value for one or more frames of the data. Additionally, or alternatively, each bitrate of the one or more bitrates may correspond to a respective QoE value for one or more frames of the data.

In some cases, the UE 115-c (e.g., the lower protocol layers 490) may also transmit an indication of the threshold QoE value associated with the application client(s) 405 (e.g., received at 450) to the UX controller 410. In some cases, the UX controller 410 may receive multiple threshold QoE values for one or more application clients 405 (e.g., or UEs 115). In some cases, the UE 115-c may transmit the indication of the threshold QoE value in the transmission of the UX information, or the UE 115-c may transmit the indication of the threshold QoE value separately from the UX information in at least one of uplink packet metadata, or a NAS message, or an RRC message, or a MAC-CE, or an uplink control information (UCI) message comprising the first indication, or a combination thereof.

In some cases, the UE 115-c (e.g., the lower protocol layers 490) may transmit (e.g., in the UX information or a separate transmission or message) other information to the UX controller 410. For example, the other information may include an indication of a validity duration for the UX information (e.g., a quantity of frames of the data, a time duration, or both). Additionally, or alternatively, the other information may include an indication of an accuracy associated with the UX information based on the UX information comprising one or more predicted bitrates corresponding to one or more respective QoE values.

The UX information, the threshold QoE value for the application client 405 (e.g., as received at 450), or both, may be communicated (e.g., from the application client 405 to the UX controller 410) in one or more manners. For example, the UE 115-c (e.g., the lower protocol layers 490) may include the UX information, an indication of the threshold QoE value, or both, in (e.g., may piggyback the UE information on) metadata for a PDU (e.g., such as an RTP-HE, such as a header extension in a general packet radio service (GPRS) transport protocol (GTP) for user information (GTP-U)). For example, a user plane function of the UE 115-c or application client 405 may extract PDU set metadata and add the UX information, the indication of the threshold QoE value, or both, thereto. The UE 115-c may send the PDU set metadata (e.g., along with a PDU in a transmission) to the UX controller 410. In some cases, to perform such functions, the user plane function may monitor a header portion of one or more PDUs (e.g., one or more uplink packets, RTP packets) sent from the UE 115-c.

Additionally, or alternatively, the application client 405 may send the UX information for the data to the lower protocol layers 490 (e.g., via the cross-layer API, at 450), and the UE 115-c (e.g., the lower protocol layers 490) may transmit the UX information to the UX controller 410, the network entity 105-c (e.g., or both, if the UX controller 410 is part of the network entity 105-c), or an application server associated with the data via NAS signaling, RRC signaling, MAC-CE, or UCI message. If the UE 115-c transmits the UX information to the network entity 105-c (e.g., and the UX controller 410 is separate from the network entity 105-c or a logical entity in the network entity 105-c), the network entity 105-c may forward the UX information to the UX controller 410. Alternatively, if the UE 115-c transmits the UX information to the application server, the application server may forward the UX information to the UX controller 410. For example, the application server may forward the UX information to the UX controller 410 over a control plane (e.g., via an application function or network exposure function) or over a user plane (e.g., using the PDU set metadata, such as the RTP-HE).

The UE 115-c may transmit the UX information according to the UX report configuration received from the UX controller 410 (e.g., at 425). For example, the UE 115-c may transmit the UX information according to the periodicity, or in response to an occurrence of one or more trigger events indicated in the UX report configuration.

At 460 and 465, the network entity 105-c and UX controller 410 may exchange channel information and RAN configuration parameters, similar to operations described at 440 and 445, respectively. For example, the network entity 105-c may transmit the channel information to the UX controller 410 according to the UX report configuration for the network entity 105-c (e.g., obtained at 435), such as according to a periodicity or in response to a trigger event.

At 470, the UX controller 410 may determine and output (e.g., to the UE 115-c, to one or more intermediate entities) a resource assignment, which may include an indication of at least an assigned bitrate (e.g., a recommended bitrate (RBR)), or an assigned QoE value, or both, for the UE 115-c (e.g., for the application client 405). Additionally, or alternatively, the resource assignment may include an indication of a percentage of uplink congestion that is assigned to the UE 115-c. For example, the resource assignment may be determined at the UX controller 410 based on the UX information from the UE 115-c (e.g., from the application client 405) and the channel information from the network entity 105-c. Additionally, or alternatively, the resource assignment may include an indication (e.g., a flag) of whether the threshold QoE value for the application client 405 is achievable based on current network conditions associated with a cell that includes the UE 115-c. In some cases, the UX controller 410 may output multiple resource assignments serially or concurrently, or may output a single transmission that indicates resource assignments for one or more UEs 115 (e.g., for one or more application clients 405).

In some cases, the UX controller 410 may determine the resource assignment prior to outputting the resource assignment. For example, the UX controller 410 may determine the assigned bitrate, the assigned QoE value, the assigned percentage of uplink congestion, or any combination thereof, for one or more UEs 115 including the UE 115-c based on the UX information (e.g., received at 455), the channel information (e.g., received at 435, 460, or both), or both. Additionally, or alternatively, determining the resource assignment may include attempting to satisfy any threshold bitrates received from the UE 115-c (e.g., as part of the UX information), the threshold QoE values for the application client 405, or both. In one example, the UX controller 410 may determine the resource assignment based on available wireless communication resources (e.g., available bitrate) and multiple threshold QoE values for multiple application clients 405. The UX controller 410 may determine the resource assignment to improve (e.g., attempt to optimize) one or more parameters (e.g., as described with respect to FIG. 2).

The UE 115-c (e.g., the lower protocol layers 490) may receive the resource assignment via multiple techniques. For example, the UE 115-c may receive the resource assignment via a MAC-CE or a downlink control information (DCI) message (e.g., from the network entity 105-c, from the UX controller 410). Additionally, or alternatively, the network entity 105-c (e.g., or the UX controller 410) may output the resource assignment to an application server associated with the data, and the application server (e.g., or another UE 115 via D2D signaling) may forward the resource assignment to the UE 115-c. For example, the network entity 105-c may mark an explicit congestion notification (ECN) or a low-latency, low-loss, scalable throughput (L4S) field in an uplink IP packet to be forwarded to the UE 115-c. In another example, if the resource assignment includes an indication of a percentage of uplink congestion that is assigned to the UE 115-c, the network entity 105-c (e.g., or UX controller 410) may directly transmit the resource assignment to the UE 115-c. In another example, the network entity 105-c (e.g., or the UX controller 410) may transmit the resource assignment to an application server associated with the application client 405 via a network allocation function or an application function interface, and the application server may transmit the resource assignment to the UE 115-c (e.g., directly to the application client 405). For example, the network entity 105-c may already transmit some QoS notifications to the application function (e.g., from the network entity 105-c through an access and mobility management function, a session management function, and a policy control function, such as to convey an inability on the network entity 105-c to handle a guaranteed flow bitrate (GFBR) for uplink traffic flow) to the application server. In some cases, the network entity 105-c (e.g., or the UX controller 410) may append the resource assignment to such QoS notifications.

In some cases, the UX controller 410 may determine whether to transmit (e.g., or output) the resource assignment to the UE 115-c. For example, the UX controller 410 may outputted the resource assignment in response to a trigger condition, where the trigger condition may be that the resource assignment for the UE 115-c (e.g., the application client 405) be different from a previous resource assignment for the UE 115-c. That is, if the resource assignment for the UE 115-c changes (e.g., does not remain unchanged) based on the UX information and channel information, the UX controller 410 may output the changed resource assignment for the UE 115-c or one or more other UEs 115.

At 475, in some cases, the lower protocol layers 490 may forward the resource assignment to the application client 405. For example, the lower protocol layers 490 may send the resource assignment to the application client 405 via a cross-layer API. After receiving the resource assignment, the application client 405 may adapt an encoding bitrate for data (e.g., the data associated with the UX information) according to the resource assignment. In some cases, if the resource assignment indicates that the threshold QoE value for the application client 405 may not be satisfied, the application client may update one or more parameters to reduce the threshold QoE value, such as reducing a quality of the data to be sent by the lower protocol layers 490, reducing a frame rate of the data to be sent by the lower protocol layers 490, or one or more other parameters. Alternatively, the application client 405 may continue with operations as normal regardless of an unachievable threshold QoE value.

At 480, the application client 405 may transmit the data associated with the UX information to the lower protocol layers 490 of the UE 115-c. For example, the application client 405 may encode the data in accordance with the resource assignment (e.g., the assigned bitrate, the assigned QOE value, the assigned percentage of uplink congestion) and transmit the encoded data to the lower protocol layers 490 for uplink transmission. For example, the application client 405 may determine a bitrate to use for encoding the data if the resource assignment indicates an assigned QoE value or assigned uplink congestion level, and the application client may encode the data according to the assigned or determined bitrate.

At 485, the UE 115-c (e.g., the lower protocol layers 490) may transmit the encoded data (e.g., uplink data) in accordance with the resource assignment, such as according to the assigned bitrate, the assigned QoE value, the assignment percentage of uplink congestion, or any combination thereof, based on receiving the encoded data from the application client 405. In some cases, as referred to herein, the UE 115-c transmitting the data in accordance with the resource assignment may include the application client generating, encoding, and transmitting the data to the lower protocol layers 490 in accordance with the resource assignment.

According to the techniques described in the process flow 400, a wireless communications system may experience increased QoE capacity. That is, the quantity of UEs 115 that may be supported by the wireless communications system (e.g., while maintaining a threshold QoE value) may increase. For example, intelligent distribution of resources (e.g., bitrate, QoE, uplink congestion) by the UX controller 410 may allow for some UEs 115 (e.g., UEs 115 with poor channel conditions, relatively complex uplink data, or both) to use a higher bitrate or QoE available in the wireless communications system by reducing bitrate to other UEs 115 (e.g., UEs 115 with good channel conditions, relatively simple data, or both), which may result in overall increased QoE for the wireless communications system.

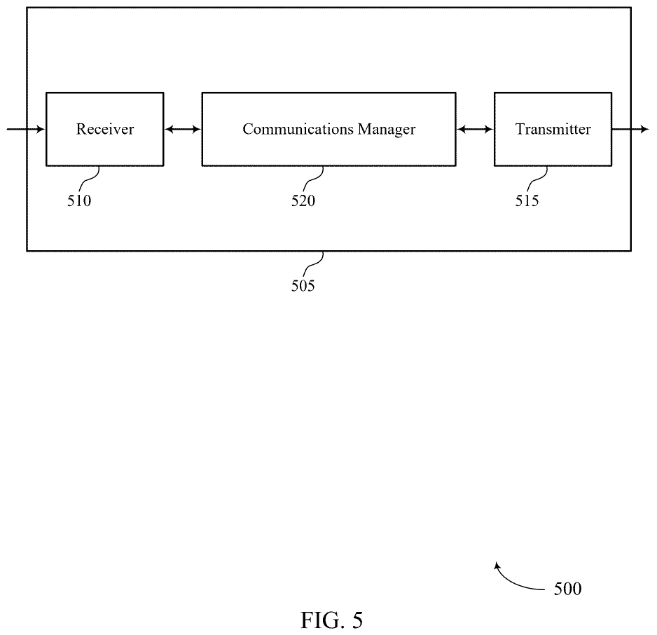

FIG. 5 shows a block diagram 500 of a device 505 that supports UX based resource configurations in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include one or more processors, memory coupled with the one or more processors, and instructions stored in the memory that are executable by the one or more processors to enable the one or more processors to perform UX based resource configuration features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to UX based resource configurations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UX based resource configurations). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of UX based resource configurations as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a first indication of one or more bitrates corresponding to one or more respective QoE values associated with transmission of data from the UE. The communications manager 520 is capable of, configured to, or operable to support a means for receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values. The communications manager 520 is capable of, configured to, or operable to support a means for transmitting the data in accordance with the assigned bitrate, or the assigned QoE value, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources. For example, by transmitting UX information to the UX controller, the UX controller may intelligently redistribute resources (e.g., bitrate) for the UE 115 to use, which may lead to increased QoE values in a wireless communications system with a same amount of resources.

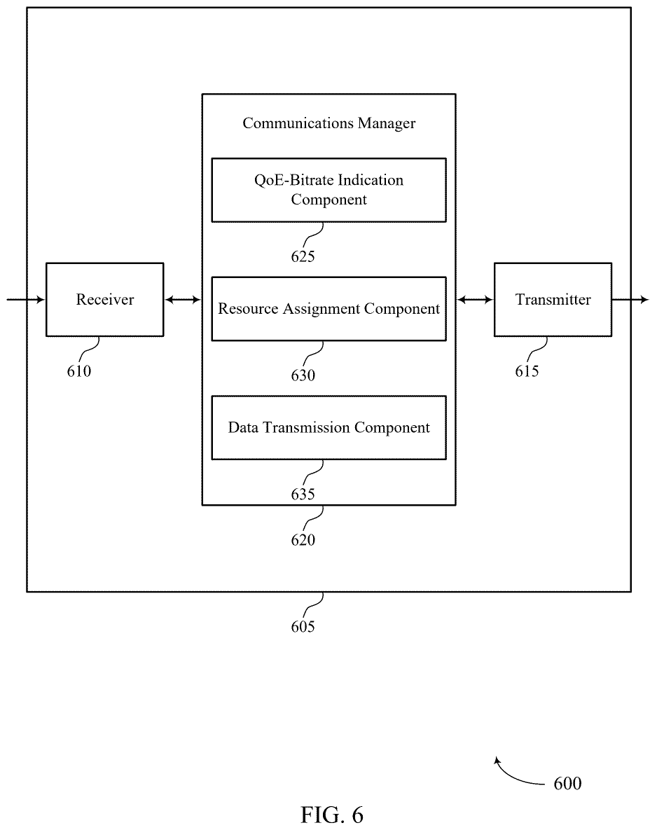

FIG. 6 shows a block diagram 600 of a device 605 that supports UX based resource configurations in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to UX based resource configurations). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UX based resource configurations). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of UX based resource configurations as described herein. For example, the communications manager 620 may include a QoE-bitrate indication component 625, a resource assignment component 630, a data transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The QoE-bitrate indication component 625 is capable of, configured to, or operable to support a means for transmitting a first indication of one or more bitrates corresponding to one or more respective QoE values associated with transmission of data from the UE. The resource assignment component 630 is capable of, configured to, or operable to support a means for receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values. The data transmission component 635 is capable of, configured to, or operable to support a means for transmitting the data in accordance with the assigned bitrate, or the assigned QoE value, or both.

In some cases, the QoE-bitrate indication component 625, the resource assignment component 630, and the data transmission component 635 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of UX based resource configuration discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

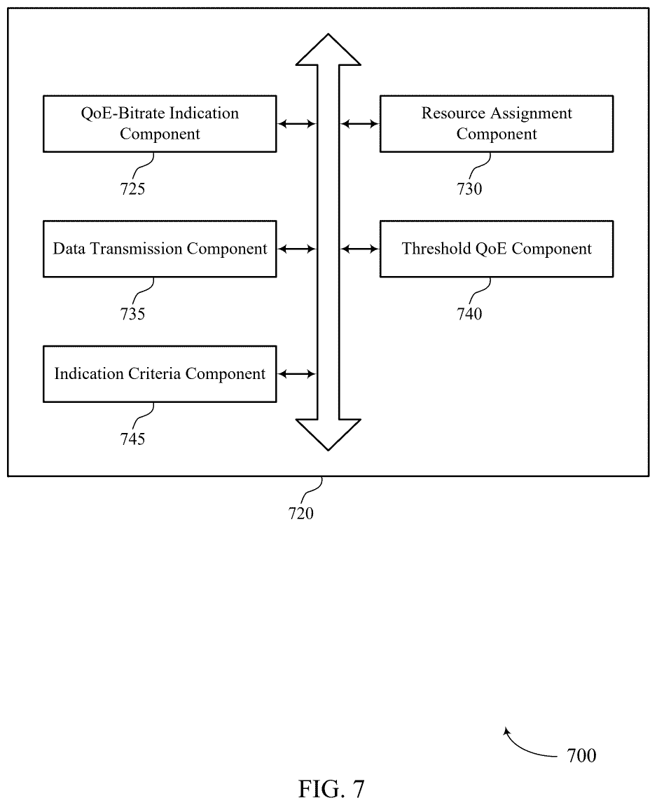

FIG. 7 shows a block diagram 700 of a communications manager 720 that supports UX based resource configurations in accordance with one or more aspects of the present disclosure. The communications manager 720 may be an example of aspects of a communications manager 520, a communications manager 620, or both, as described herein. The communications manager 720, or various components thereof, may be an example of means for performing various aspects of UX based resource configurations as described herein. For example, the communications manager 720 may include a QoE-bitrate indication component 725, a resource assignment component 730, a data transmission component 735, a threshold QoE component 740, an indication criteria component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The QoE-bitrate indication component 725 is capable of, configured to, or operable to support a means for transmitting a first indication of one or more bitrates corresponding to one or more respective QoE values associated with transmission of data from the UE. The resource assignment component 730 is capable of, configured to, or operable to support a means for receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values. The data transmission component 735 is capable of, configured to, or operable to support a means for transmitting the data in accordance with the assigned bitrate, or the assigned QoE value, or both.

In some examples, the QoE-bitrate indication component 725 is capable of, configured to, or operable to support a means for transmitting, in response to a change in at least one of the data, or a channel condition of a channel associated with the UE, or a congestion metric associated with a cell that includes the UE, or a combination thereof, a third indication of one or more second bitrates corresponding to one or more respective second QoE values associated with transmission of second data from the UE.

In some examples, the one or more bitrates include a finite set of bitrates based on a quantization capability at the UE.

In some examples, the one or more bitrates include a threshold bitrate corresponding to a threshold QoE value associated with transmission of the data from the UE.

In some examples, the one or more bitrates indicate a range of possible bitrates corresponding to each of the one or more respective QoE values.

In some examples, the first indication of the one or more bitrates includes a pattern of threshold bitrates corresponding to a threshold QoE value for a set of multiple frames of the data.

In some examples, the QoE-bitrate indication component 725 is capable of, configured to, or operable to support a means for transmitting a third indication of a validity duration for the one or more bitrates corresponding to the one or more respective QoE values, where the validity duration includes a quantity of frames of the data, a time duration, or both.

In some examples, each bitrate of the one or more bitrates corresponds to a respective QoE value for one or more frames of the data.

In some examples, the QoE-bitrate indication component 725 is capable of, configured to, or operable to support a means for transmitting a third indication of an accuracy associated with the one or more bitrates of the first indication based on the one or more bitrates including one or more predicted bitrates corresponding to the one or more respective QoE values.

In some examples, to support transmitting the first indication of the one or more bitrates, the QoE-bitrate indication component 725 is capable of, configured to, or operable to support a means for transmitting at least one of uplink packet metadata including the first indication, or a NAS message including the first indication, or an RRC message including the first indication, or a MAC-CE including the first indication, or a UCI message comprising the first indication, or a combination thereof.

In some examples, the threshold QoE component 740 is capable of, configured to, or operable to support a means for transmitting a third indication of a threshold QoE value associated with transmission of the data from the UE, where the assigned bitrate, or the assigned QoE value, or both are based on the third indication of the threshold QoE.

In some examples, to support transmitting the third indication of the threshold QoE value, the threshold QoE component 740 is capable of, configured to, or operable to support a means for transmitting at least one of uplink packet metadata including the third indication, or a NAS message including the third indication, or an RRC message including the third indication, or a MAC-CE including the third indication, or a UCI message comprising the third indication, or a combination thereof.

In some examples, the threshold QoE component 740 is capable of, configured to, or operable to support a means for receiving a fourth indication of whether the threshold QoE value is achievable based on current network conditions associated with a cell including the UE.

In some examples, the indication criteria component 745 is capable of, configured to, or operable to support a means for receiving a third indication of one or more criteria for transmitting the first indication of the one or more bitrates, where the one or more criteria include at least one of a periodicity for transmitting the first indication, or a trigger event for transmitting the first indication, or both.

In some examples, to support receiving the third indication of the one or more criteria, the indication criteria component 745 is capable of, configured to, or operable to support a means for receiving at least one of downlink packet metadata including the third indication, or a NAS message including the third indication, or an RRC message including the third indication, or a MAC-CE including the third indication, or a UCI message comprising the third indication, or a combination thereof.

In some examples, to support receiving the second indication of the assigned bitrate, or the assigned QoE value, or both, the resource assignment component 730 is capable of, configured to, or operable to support a means for receiving a MAC-CE including the second indication, or a DCI message comprising the second indication, or a combination thereof.

In some examples, the second indication of the assigned bitrate, or the assigned QoE value, or both is received from an application server associated with the data.

In some examples, the resource assignment component 730 is capable of, configured to, or operable to support a means for receiving a third indication of a percentage of uplink congestion assigned to the UE.

In some examples, the one or more bitrates indicate a frame size associated with a frame of the data, the frame size corresponding to a respective QoE value associated with transmission of the frame.

In some cases, the QoE-bitrate indication component 725, the resource assignment component 730, the data transmission component 735, the threshold QoE component, and the indication criteria component 745 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of UX based resource configuration discussed herein.

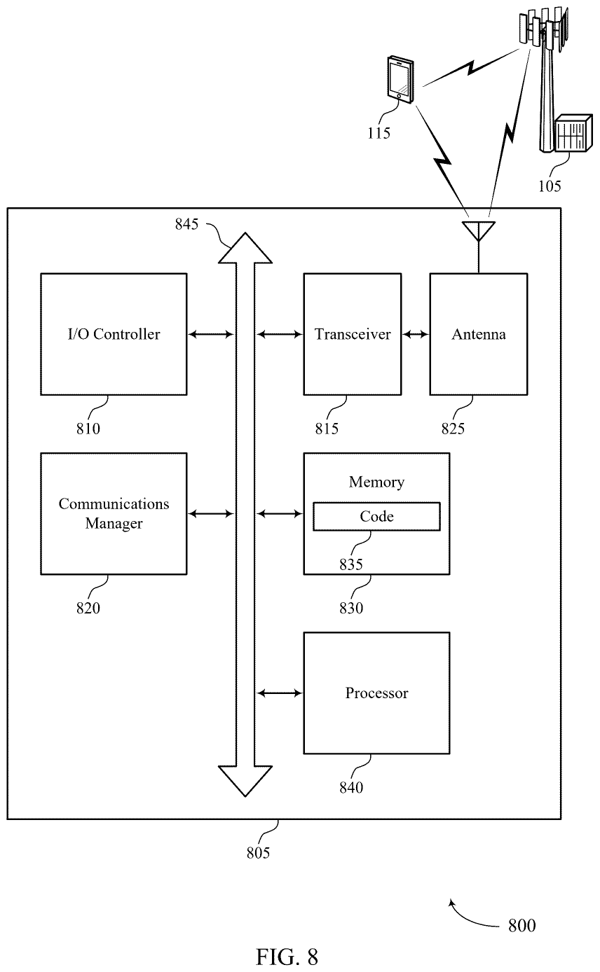

FIG. 8 shows a diagram of a system 800 including a device 805 that supports UX based resource configurations in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting UX based resource configurations). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a first indication of one or more bitrates corresponding to one or more respective QoE values associated with transmission of data from the UE. The communications manager 820 is capable of, configured to, or operable to support a means for receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values. The communications manager 820 is capable of, configured to, or operable to support a means for transmitting the data in accordance with the assigned bitrate, or the assigned QoE value, or both.

By including or configuring the communications manager 820 in accordance with examples as described herein, the device 805 may support techniques for improved UX related to reduced processing and more efficient utilization of communication resources. For example, a UE 115 with poor channel conditions or transmitting relatively complex data may receive increased resources (e.g., bitrate or QoE), which may improve UX for the UE 115.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of UX based resource configurations as described herein, or the at least one processor 840 and the at least one memory 830 may be otherwise configured to, individually or collectively, perform or support such operations.

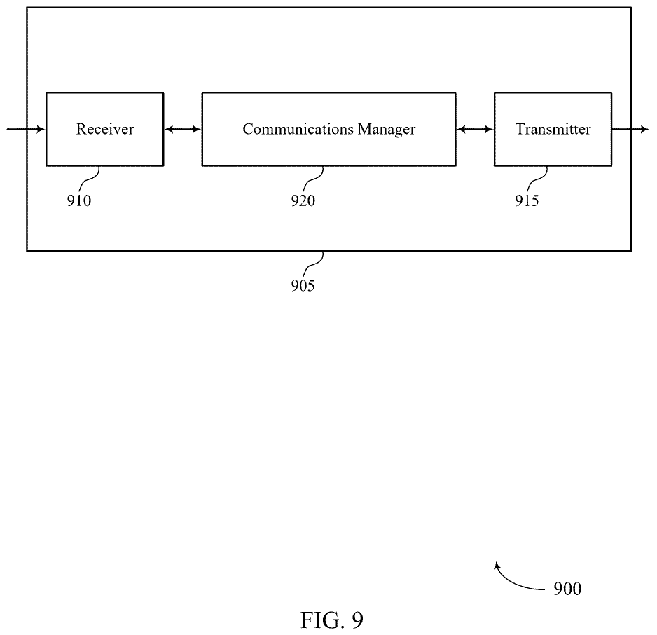

FIG. 9 shows a block diagram 900 of a device 905 that supports UX based resource configurations in accordance with one or more aspects of the present disclosure. The device 905 may be an example of aspects of a network entity 105 or an external device as described herein. The device 905 may include a receiver 910, a transmitter 915, and a communications manager 920. The device 905, or one or more components of the device 905 (e.g., the receiver 910, the transmitter 915, the communications manager 920), may include one or more processors, memory coupled with the one or more processors, and instructions stored in the memory that are executable by the one or more processors to enable the one or more processors to perform UX based resource configuration features discussed herein. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of UX based resource configurations as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for obtaining a first indication of one or more bitrates corresponding to one or more respective QoE values associated with transmission of data from a first UE. The communications manager 920 is capable of, configured to, or operable to support a means for outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources. For example, by receiving UX information and intelligently redistributing resources (e.g., bitrate) for one or more UEs 115 to use, a wireless communications system may experience increased QoE values with a same amount of resources.

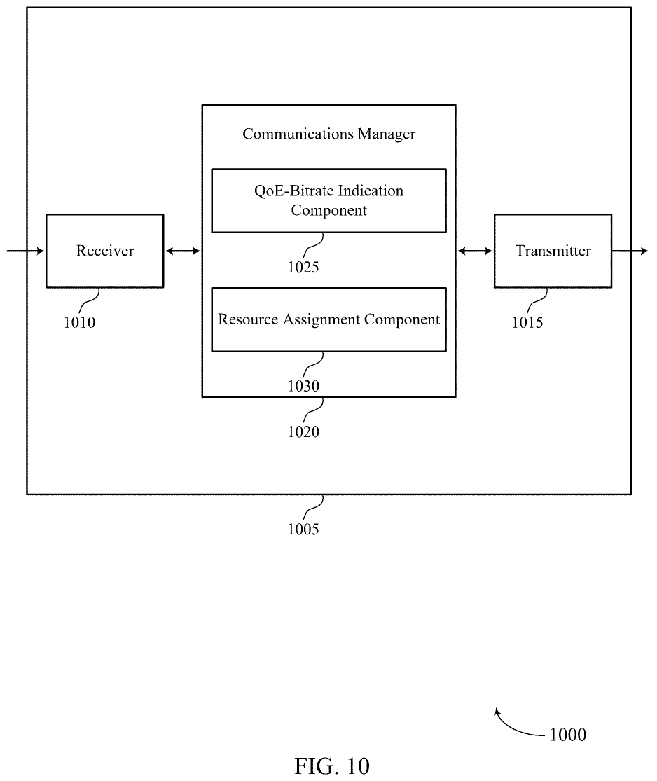

FIG. 10 shows a block diagram 1000 of a device 1005 that supports UX based resource configurations in accordance with one or more aspects of the present disclosure. The device 1005 may be an example of aspects of a device 905, a network entity 105, or an external device 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UX based resource configurations as described herein. For example, the communications manager 1020 may include a QoE-bitrate indication component 1025 a resource assignment component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The QoE-bitrate indication component 1025 is capable of, configured to, or operable to support a means for obtaining a first indication of one or more bitrates corresponding to one or more respective QoE values associated with transmission of data from a first UE. The resource assignment component 1030 is capable of, configured to, or operable to support a means for outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

In some cases, the QoE-bitrate indication component 1025 and the resource assignment component 1030 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of UX based resource configuration discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

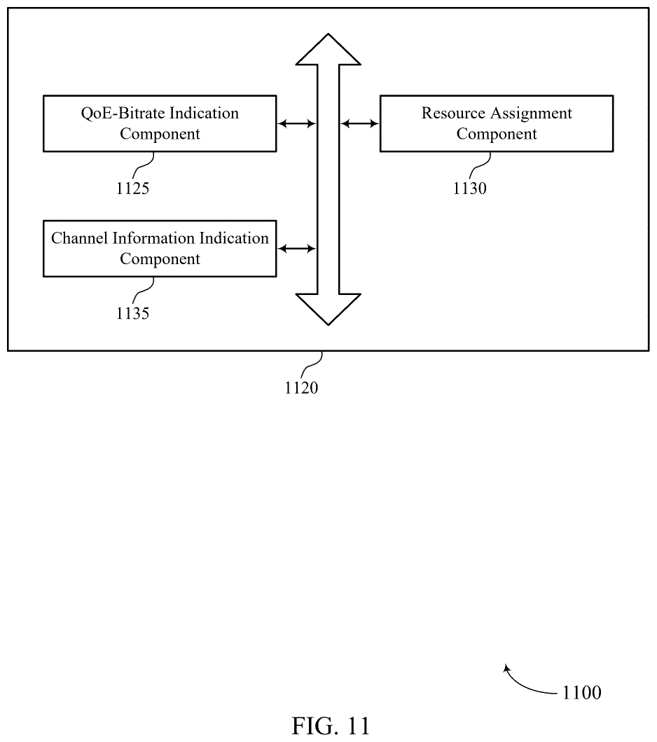

FIG. 11 shows a block diagram 1100 of a communications manager 1120 that supports UX based resource configurations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UX based resource configurations as described herein. For example, the communications manager 1120 may include a QoE-bitrate indication component 1125, a resource assignment component 1130, a channel information indication component 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The QoE-bitrate indication component 1125 is capable of, configured to, or operable to support a means for obtaining a first indication of one or more bitrates corresponding to one or more respective QoE values associated with transmission of data from a first UE. The resource assignment component 1130 is capable of, configured to, or operable to support a means for outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

In some examples, the channel information indication component 1135 is capable of, configured to, or operable to support a means for obtaining a third indication of channel information associated with a channel for communication with the first UE, where the assigned bitrate, or the assigned QoE value, or both are further determined based on the third indication of the channel information.

In some examples, the first indication of the one or more bitrates corresponding to the one or more respective QoE values is obtained from at least a network entity, or an application server associated with the data, or both.

In some examples, the QoE-bitrate indication component 1125 is capable of, configured to, or operable to support a means for receiving a set of multiple third indications of threshold QoE values associated with transmission of data from a set of multiple UEs including the first UE, where the assigned bitrate, or the assigned QoE value, or both are based on the set of multiple third indications. In some examples, the resource assignment component 1130 is capable of, configured to, or operable to support a means for determining the assigned bitrate, or the assigned QoE value, or both based on available wireless communication resources and the set of multiple third indications of the threshold QoE values.

In some examples, the resource assignment component 1130 is capable of, configured to, or operable to support a means for determining the assigned bitrate, or the assigned QoE value, or both based on a minimum QoE value associated with any UE of a set of multiple UEs including the second UE.

In some examples, the wireless device includes at least a separate entity from a network entity that is a recipient of the data from the first UE, a logical entity of the network entity, or both.

In some examples, the second indication of the assigned bitrate, or the assigned QoE value, or both is outputted to an application server associated with the data.

In some examples, the second indication of the assigned bitrate, or the assigned QoE value, or both is outputted in response to the assigned bitrate, or the assigned QoE, or both being different than a previously assigned bitrate, or a previously assigned QoE value, or both.

In some examples, the second UE includes the first UE.

In some cases, the QoE-bitrate indication component 1125, the resource assignment component 1130, and the channel information indication component 1135 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of UX based resource configuration discussed herein.

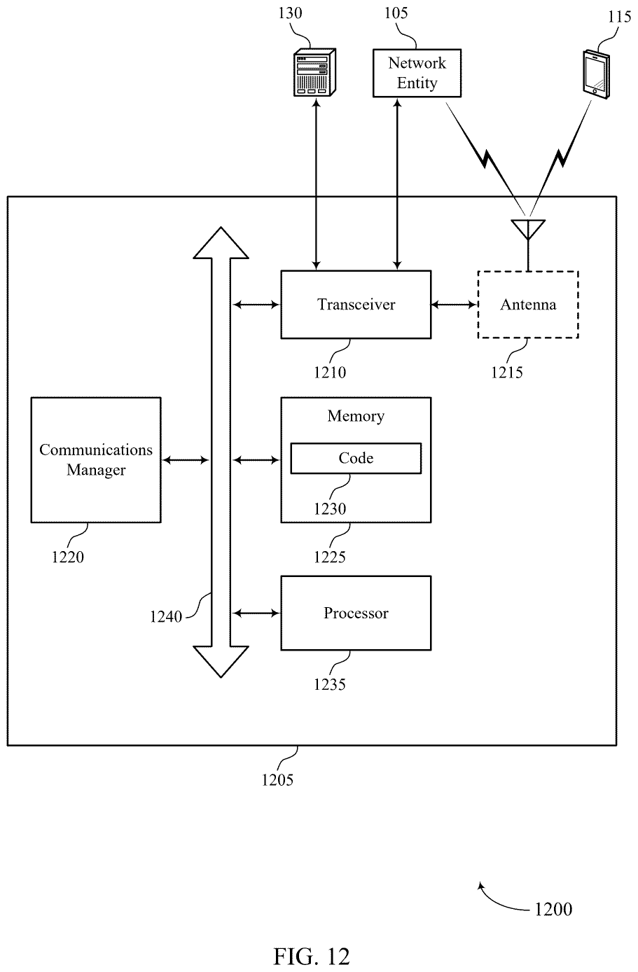

FIG. 12 shows a diagram of a system 1200 including a device 1205 that supports UX based resource configurations in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting UX based resource configurations). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for obtaining a first indication of one or more bitrates corresponding to one or more respective QoE values associated with transmission of data from a first UE. The communications manager 1220 is capable of, configured to, or operable to support a means for outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values.

By including or configuring the communications manager 1220 in accordance with examples as described herein, the device 1205 may support techniques for more efficient utilization of communication resources. For example, a network entity 105 or UX controller may allocate, to a UE 115 with poor channel conditions or transmitting relatively complex data, an increased resource assignment (e.g., bitrate or QoE), which may improve UX for the UE 115 without noticeable reducing UX at one or more other UEs 115 with better channel conditions or relatively simple data to transmit.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of UX based resource configurations as described herein, or the at least one processor 1235 and the at least one memory 1225 may be otherwise configured to, individually or collectively, perform or support such operations.

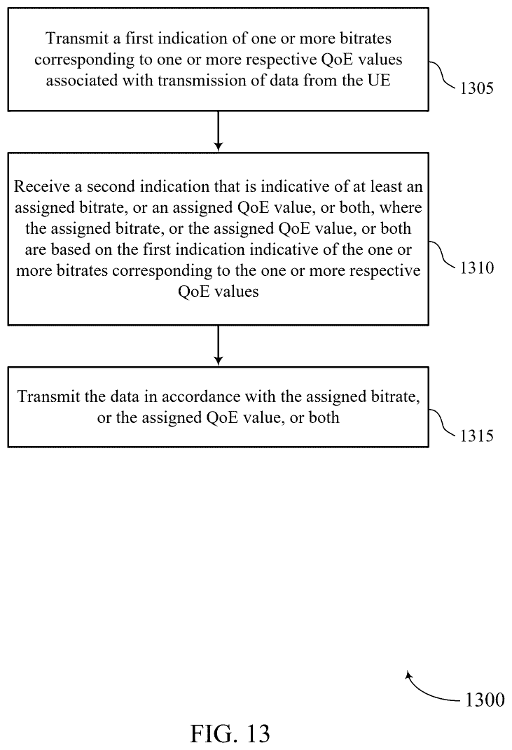

FIG. 13 shows a flowchart illustrating a method 1300 that supports UX based resource configurations in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a first indication of one or more bitrates corresponding to one or more respective QoE values associated with transmission of data from the UE. The operations of 1305 may be performed in accordance with examples as disclosed herein. In some examples, aspects of the operations of 1305 may be performed by a QoE-bitrate indication component 725 as described with reference to FIG. 7.

At 1310, the method may include receiving a second indication that is indicative of at least an assigned bitrate, or an assigned QoE value, or both, where the assigned bitrate, or the assigned QoE value, or both are based on the first indication indicative of the one or more bitrates corresponding to the one or more respective QoE values. The operations of 1310 may be performed in accordance with examples as disclosed herein. In some examples, aspects of the operations of 1310 may be performed by a resource assignment component 730 as described with reference to FIG. 7.

At 1315, the method may include transmitting the data in accordance with the assigned bitrate, or the assigned QoE value, or both. The operations of 1315 may be performed in accordance with examples as disclosed herein. In some examples, aspects of the operations of 1315 may be performed by a data transmission component 735 as described with reference to FIG. 7.

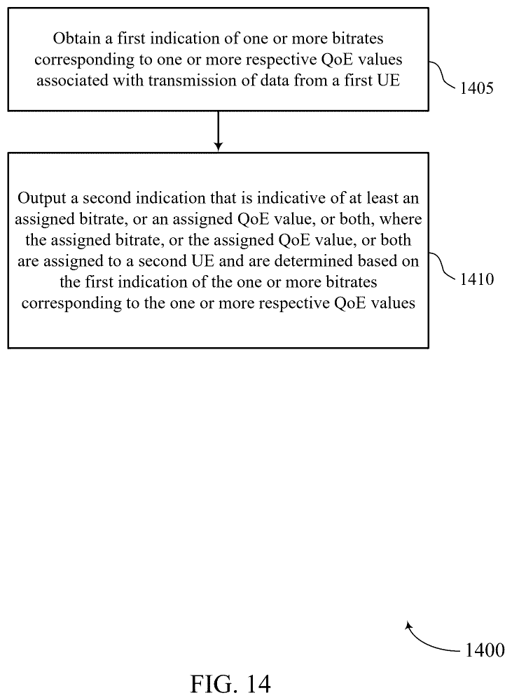

FIG. 14 shows a flowchart illustrating a method 1400 that supports UX based resource configurations in accordance with one or more aspects of the present disclosure. The operations of the method 1400 may be implemented by a network entity or an external device or its components as described herein. For example, the operations of the method 1400 may be performed by a network entity or an external device as described with reference to FIGS. 1 through 4 and 9 through 13. In some examples, a network entity or an external device may execute a set of instructions to control the functional elements of the network entity or the external device to perform the described functions. Additionally, or alternatively, the network entity or the external device may perform aspects of the described functions using special-purpose hardware.

At 1405, the method may include obtaining a first indication of one or more bitrates corresponding to one or more respective QoE values associated with transmission of data from a first UE. The operations of 1405 may be performed in accordance with examples as disclosed herein. In some examples, aspects of the operations of 1405 may be performed by a QoE-bitrate indication component 1125 as described with reference to FIG. 11.

At 1410, the method may include outputting a second indication that is indicative of at least an assigned bitrate, or an assigned QoE value, or both, where the assigned bitrate, or the assigned QoE value, or both are assigned to a second UE and are determined based on the first indication of the one or more bitrates corresponding to the one or more respective QoE values. The operations of 1410 may be performed in accordance with examples as disclosed herein. In some examples, aspects of the operations of 1410 may be performed by a resource assignment component 1130 as described with reference to FIG. 11.

The following provides an overview of aspects of the present disclosure:
Aspect 1: A method for wireless communications at a UE, comprising: transmitting a first indication of one or more bitrates corresponding to one or more respective QoE values associated with transmission of data from the UE; receiving a second indication that is indicative of at least an assigned bitrate, or an assigned QoE value, or both, wherein the assigned bitrate, or the assigned QoE value, or both are based at least in part on the first indication indicative of the one or more bitrates corresponding to the one or more respective QoE values; and transmitting the data in accordance with the assigned bitrate, or the assigned QoE value, or both.
Aspect 2: The method of aspect 1, further comprising: transmitting, in response to a change in at least one of the data, or a channel condition of a channel associated with the UE, or a congestion metric associated with a cell that includes the UE, or a combination thereof, a third indication of one or more second bitrates corresponding to one or more respective second QoE values associated with transmission of second data from the UE.
Aspect 3: The method of any of aspects 1 through 2, wherein the one or more bitrates comprise a finite set of bitrates based at least in part on a quantization capability at the UE.
Aspect 4: The method of any of aspects 1 through 3, wherein the one or more bitrates comprise a threshold bitrate corresponding to a threshold QoE value associated with transmission of the data from the UE.
Aspect 5: The method of any of aspects 1 through 4, wherein the one or more bitrates indicate a range of possible bitrates corresponding to each of the one or more respective QoE values.
Aspect 6: The method of any of aspects 1 through 5, wherein the first indication of the one or more bitrates comprises a pattern of threshold bitrates corresponding to a threshold QoE value for a plurality of frames of the data.
Aspect 7: The method of any of aspects 1 through 6 further comprising: transmitting a third indication of a validity duration for the one or more bitrates corresponding to the one or more respective QoE values, wherein the validity duration comprises a quantity of frames of the data, a time duration, or both.
Aspect 8: The method of any of aspects 1 through 7, wherein each bitrate of the one or more bitrates corresponds to a respective QoE value for one or more frames of the data.
Aspect 9: The method of any of aspects 1 through 8 further comprising: transmitting a third indication of an accuracy associated with the one or more bitrates of the first indication based at least in part on the one or more bitrates comprising one or more predicted bitrates corresponding to the one or more respective QoE values.
Aspect 10: The method of any of aspects 1 through 9, wherein transmitting the first indication of the one or more bitrates comprises: transmitting at least one of uplink packet metadata comprising the first indication, or a NAS message comprising the first indication, or a RRC message comprising the first indication, or a MAC-CE comprising the first indication, or an UCI message comprising the first indication, or a combination thereof.
Aspect 11: The method of any of aspects 1 through 10, further comprising: transmitting a third indication of a threshold QoE value associated with transmission of the data from the UE, wherein the assigned bitrate, or the assigned QoE value, or both are based at least in part on the third indication of the threshold QoE.
Aspect 12: The method of aspect 11, wherein transmitting the third indication of the threshold QoE value comprises: transmitting at least one of uplink packet metadata comprising the third indication, or a NAS message comprising the third indication, or a RRC message comprising the third indication, or a MAC-CE comprising the third indication, or an UCI message comprising the third indication, or a combination thereof.
Aspect 13: The method of any of aspects 11 through 12, further comprising: receiving a fourth indication of whether the threshold QoE value is achievable based at least in part on current network conditions associated with a cell comprising the UE.
Aspect 14: The method of any of aspects 1 through 13, further comprising: receiving a third indication of one or more criteria for transmitting the first indication of the one or more bitrates, wherein the one or more criteria comprise at least one of a periodicity for transmitting the first indication, or a trigger event for transmitting the first indication, or both.
Aspect 15: The method of aspect 14, wherein receiving the third indication of the one or more criteria comprises: receiving at least one of downlink packet metadata comprising the third indication, or a NAS message comprising the third indication, or a RRC message comprising the third indication, or a MAC-CE comprising the third indication, or an UCI message comprising the third indication, or a combination thereof.
Aspect 16: The method of any of aspects 1 through 15, wherein receiving the second indication of the assigned bitrate, or the assigned QoE value, or both comprises: receiving a MAC-CE comprising the second indication, or a DCI message comprising the second indication, or a combination thereof.
Aspect 17: The method of any of aspects 1 through 16, wherein the second indication of the assigned bitrate, or the assigned QoE value, or both is received from an application server associated with the data.
Aspect 18: The method of any of aspects 1 through 17, further comprising: receiving a third indication of a percentage of uplink congestion assigned to the UE.
Aspect 19: The method of any of aspects 1 through 18, wherein the one or more bitrates indicate a frame size associated with a frame of the data, the frame size corresponding to a respective QoE value associated with transmission of the frame.
Aspect 20: A method for wireless communications at a wireless device, comprising: obtaining a first indication of one or more bitrates corresponding to one or more respective QoE values associated with transmission of data from a first UE; and outputting a second indication that is indicative of at least an assigned bitrate, or an assigned QoE value, or both, wherein the assigned bitrate, or the assigned QoE value, or both are assigned to a second UE and are determined based at least in part on the first indication of the one or more bitrates corresponding to the one or more respective QoE values.
Aspect 21: The method of aspect 20, further comprising: obtaining a third indication of channel information associated with a channel for communication with the first UE, wherein the assigned bitrate, or the assigned QoE value, or both are further determined based at least in part on the third indication of the channel information.
Aspect 22: The method of any of aspects 20 through 21, wherein the first indication of the one or more bitrates corresponding to the one or more respective QoE values is obtained from at least a network entity, or an application server associated with the data, or both.
Aspect 23: The method of any of aspects 20 through 22, further comprising: receiving a plurality of third indications of threshold QoE values associated with transmission of data from a plurality of UEs including the first UE, wherein the assigned bitrate, or the assigned QoE value, or both are based at least in part on the plurality of third indications; and determining the assigned bitrate, or the assigned QoE value, or both based at least in part on available wireless communication resources and the plurality of third indications of the threshold QoE values.
Aspect 24: The method of any of aspects 20 through 23, further comprising: determining the assigned bitrate, or the assigned QoE value, or both based at least in part on a minimum QoE value associated with any UE of a plurality of UEs including the second UE.
Aspect 25: The method of any of aspects 20 through 24, wherein the wireless device comprises at least a separate entity from a network entity that is a recipient of the data from the first UE, a logical entity of the network entity, or both.
Aspect 26: The method of any of aspects 20 through 25, wherein the second indication of the assigned bitrate, or the assigned QoE value, or both is outputted to an application server associated with the data.
Aspect 27: The method of any of aspects 20 through 26, wherein the second indication of the assigned bitrate, or the assigned QoE value, or both is outputted in response to the assigned bitrate, or the assigned QoE, or both being different than a previously assigned bitrate, or a previously assigned QoE value, or both.
Aspect 28: The method of any of aspects 20 through 27, wherein the second UE comprises the first UE.
Aspect 29: A UE for wireless communications, comprising one or more memories storing processor-executable code, and one or more processors coupled with the one or more memories and individually or collectively operable to execute the code to cause the UE to perform a method of any of aspects 1 through 19.
Aspect 30: A UE for wireless communications, comprising at least one means for performing a method of any of aspects 1 through 19.
Aspect 31: A non-transitory computer-readable medium storing code for wireless communications, the code comprising instructions executable by one or more processors to perform a method of any of aspects 1 through 19.
Aspect 32: A wireless device for wireless communications, comprising one or more memories storing processor-executable code, and one or more processors coupled with the one or more memories and individually or collectively operable to execute the code to cause the wireless device to perform a method of any of aspects 20 through 28.
Aspect 33: A wireless device for wireless communications, comprising at least one means for performing a method of any of aspects 20 through 28.
Aspect 34: A non-transitory computer-readable medium storing code for wireless communications, the code comprising instructions executable by one or more processors to perform a method of any of aspects 20 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively configured to cause the UE to:
transmit a first indication of one or more bitrates corresponding to one or more respective quality of experience values associated with transmission of data from the UE;
receive a second indication that is indicative of at least an assigned bitrate, or an assigned quality of experience value, or both, wherein the assigned bitrate, or the assigned quality of experience value, or both are based at least in part on the first indication indicative of the one or more bitrates corresponding to the one or more respective quality of experience values; and
transmit the data in accordance with the assigned bitrate, or the assigned quality of experience value, or both.

2. The UE of claim 1, wherein the one or more processors are individually or collectively further configured to cause the UE to:
transmit, in response to a change in at least one of the data, or a channel condition of a channel associated with the UE, or a congestion metric associated with a cell that includes the UE, or a combination thereof, a third indication of one or more second bitrates corresponding to one or more respective second quality of experience values associated with transmission of second data from the UE.

3. The UE of claim 1, wherein the one or more bitrates comprise a finite set of bitrates based at least in part on a quantization capability at the UE.

4. The UE of claim 1, wherein the one or more bitrates comprise a threshold bitrate corresponding to a threshold quality of experience value associated with transmission of the data from the UE.

5. The UE of claim 1, wherein the one or more bitrates indicate a range of possible bitrates corresponding to each of the one or more respective quality of experience values.

6. The UE of claim 1, wherein the first indication of the one or more bitrates comprises a pattern of threshold bitrates corresponding to a threshold quality of experience value for a plurality of frames of the data.

7. The UE of claim 1, wherein each bitrate of the one or more bitrates corresponds to a respective quality of experience value for one or more frames of the data.

8. The UE of claim 1, wherein the one or more processors are individually or collectively configured to cause the UE to transmit the first indication of the one or more bitrates by being individually or collectively configured to cause the UE to:
transmit at least one of uplink packet metadata comprising the first indication, or a non-access stratum message comprising the first indication, or a radio resource control message comprising the first indication, or a medium access control-control element comprising the first indication, or an uplink control information message comprising the first indication, or a combination thereof.

9. The UE of claim 1, wherein the one or more processors are individually or collectively further configured to cause the UE to:
transmit a third indication of a threshold quality of experience value associated with transmission of the data from the UE, wherein the assigned bitrate, or the assigned quality of experience value, or both are based at least in part on the third indication of the threshold quality of experience.

10. The UE of claim 9, wherein the one or more processors are individually or collectively configured to cause the UE to transmit the third indication of the threshold quality of experience value by being individually or collectively configured to cause the UE to:
transmit at least one of uplink packet metadata comprising the third indication, or a non-access stratum message comprising the third indication, or a radio resource control message comprising the third indication, or a medium access control-control element comprising the third indication, or an uplink control information message comprising the third indication, or a combination thereof.

11. The UE of claim 9, wherein the one or more processors are individually or collectively further configured to cause the UE to:
receive a fourth indication of whether the threshold quality of experience value is achievable based at least in part on current network conditions associated with a cell comprising the UE.

12. The UE of claim 1, wherein the one or more processors are individually or collectively further configured to cause the UE to:
receive a third indication of one or more criteria for transmitting the first indication of the one or more bitrates, wherein the one or more criteria comprise at least one of a periodicity for transmitting the first indication, or a trigger event for transmitting the first indication, or both.

13. The UE of claim 12, wherein the one or more processors are individually or collectively configured to cause the UE to receive the third indication of the one or more criteria by being individually or collectively configured to cause the UE to:
receive at least one of downlink packet metadata comprising the third indication, or a non-access stratum message comprising the third indication, or a radio resource control message comprising the third indication, or a medium access control-control element comprising the third indication, or an uplink control information message comprising the third indication, or a combination thereof.

14. The UE of claim 1, wherein the one or more processors are individually or collectively configured to cause the UE to receive the second indication of the assigned bitrate, or the assigned quality of experience value, or both by being individually or collectively configured to cause the UE to:
receive a medium access control-control element comprising the second indication, or a downlink control information message comprising the second indication, or a combination thereof.

15. The UE of claim 1, wherein the second indication of the assigned bitrate, or the assigned quality of experience value, or both is received from an application server associated with the data.

16. The UE of claim 1, wherein the one or more processors are individually or collectively further configured to cause the UE to:
receive a third indication of a percentage of uplink congestion assigned to the UE.

17. The UE of claim 1, wherein the one or more bitrates indicate a frame size associated with a frame of the data, the frame size corresponding to a respective quality of experience value associated with transmission of the frame.

18. A wireless device, comprising:
one or more memories storing processor-executable code; and
one or more processors coupled with the one or more memories, wherein the one or more processors are individually or collectively configured to cause the wireless device to:
obtain a first indication of one or more bitrates corresponding to one or more respective quality of experience values associated with transmission of data from a first user equipment (UE); and
output a second indication that is indicative of at least an assigned bitrate, or an assigned quality of experience value, or both, wherein the assigned bitrate, or the assigned quality of experience value, or both are assigned to a second UE and are determined based at least in part on the first indication of the one or more bitrates corresponding to the one or more respective quality of experience values.

19. The wireless device of claim 18, wherein the one or more processors are individually or collectively further configured to cause the UE to:
obtain a third indication of channel information associated with a channel for communication with the first UE, wherein the assigned bitrate, or the assigned quality of experience value, or both are further determined based at least in part on the third indication of the channel information.

20. The wireless device of claim 18, wherein the first indication of the one or more bitrates corresponding to the one or more respective quality of experience values is obtained from at least a network entity, or an application server associated with the data, or both.

21. The wireless device of claim 18, wherein the one or more processors are individually or collectively further configured to cause the UE to:
receive a plurality of third indications of threshold quality of experience values associated with transmission of data from a plurality of UEs including the first UE, wherein the assigned bitrate, or the assigned quality of experience value, or both are based at least in part on the plurality of third indications; and
determine the assigned bitrate, or the assigned quality of experience value, or both based at least in part on available wireless communication resources and the plurality of third indications of the threshold quality of experience values.

22. The wireless device of claim 18, wherein the one or more processors are individually or collectively further configured to cause the UE to:
determine the assigned bitrate, or the assigned quality of experience value, or both based at least in part on a minimum quality of experience value associated with any UE of a plurality of UEs including the second UE.

23. The wireless device of claim 18, wherein the wireless device comprises at least a separate entity from a network entity that is a recipient of the data from the first UE, a logical entity of the network entity, or both.

24. The wireless device of claim 18, wherein the second indication of the assigned bitrate, or the assigned quality of experience value, or both is outputted to an application server associated with the data.

25. The wireless device of claim 18, wherein the second indication of the assigned bitrate, or the assigned quality of experience value, or both is outputted in response to the assigned bitrate, or the assigned quality of experience, or both being different than a previously assigned bitrate, or a previously assigned quality of experience value, or both.

26. The wireless device of claim 18, wherein the second UE comprises the first UE.

27. A method for wireless communications at a user equipment (UE), comprising:
transmitting a first indication of one or more bitrates corresponding to one or more respective quality of experience values associated with transmission of data from the UE;
receiving a second indication that is indicative of at least an assigned bitrate, or an assigned quality of experience value, or both, wherein the assigned bitrate, or the assigned quality of experience value, or both are based at least in part on the first indication indicative of the one or more bitrates corresponding to the one or more respective quality of experience values; and
transmitting the data in accordance with the assigned bitrate, or the assigned quality of experience value, or both.

28. The method of claim 27, further comprising:
transmitting, in response to a change in at least one of the data, or a channel condition of a channel associated with the UE, or a congestion metric associated with a cell that includes the UE, or a combination thereof, a third indication of one or more second bitrates corresponding to one or more respective second quality of experience values associated with transmission of second data from the UE.

29. The method of claim 27, wherein the one or more bitrates comprise a finite set of bitrates based at least in part on a quantization capability at the UE.

30. A method for wireless communications at a wireless device, comprising:
obtaining a first indication of one or more bitrates corresponding to one or more respective quality of experience values associated with transmission of data from a first user equipment (UE); and
outputting a second indication that is indicative of at least an assigned bitrate, or an assigned quality of experience value, or both, wherein the assigned bitrate, or the assigned quality of experience value, or both are assigned to a second UE and are determined based at least in part on the first indication of the one or more bitrates corresponding to the one or more respective quality of experience values.
